(19) United States
(12) Patent Application Publication
(10) Pub. No.: US 2013/0185753 A1
(43) Pub. Date: Jul. 18, 2013

(54) Data Management and Selection/Control System Preferably for a Video Magazine

(71) Applicant: Jason Kliot, New York, NY (US)

(72) Inventor: Jason Kliot, New York, NY (US)

(21) Appl. No.: 13/735,071

(22) Filed: Jan. 7, 2013

Related U.S. Application Data
(60) Provisional application No. 61/585,885, filed on Jan. 12, 2012.

(51) Int. Cl. H04N 21/472

(52) U.S. Cl. CPC H04N 21/47217
USPC 725/39

(57) ABSTRACT

A data management control and selection system for use with electronic display and preferably touch sensitive devices for video (and often accompanying audio) signal selections available from memory. In the preferred embodiment the system is a screen-spanning and integrated set of visual segments forming a toroid (although other geometric shapes can be used) having arc-shaped segments which extend in length or degrees around the toroid corresponding to the length in minutes and seconds of the video signal selections. The segments of the toroid are also color coded and collected/coordinated to the genre of the video signal selection to which it corresponds. By aligning (rotating or spinning of the toroid by one's finger on the touch sensitive screen or other cursor-like movement and selection mechanism) the selected segment, associated with the video signal selection will be displayed on the display screen. As the display screen then converts from prominent display of the toroid “menu wheel” to the display of the selected video signal selection, the balance of the display screen will display still videos of one or more of the other video signal selections which are available for viewing.

### RELATED APPLICATIONS

This application is a non-provisional patent application based upon and claiming priority on prior filed U.S. provisional application No. 61/585,885 filed Jan. 12, 2012, entitled: Data Management and Selection/Control System Preferably for a Video Magazine, the contents of which are expressly and fully incorporated by reference.

### BACKGROUND OF THE INVENTION

The present invention relates to a data management and selection and control system for an electronic display device. Preferably, the electronic display device is a computer, laptop, desktop, a smart phone, personal data assistant, pad, notebook, etc. Essential, however, to the present invention is a video display screen to allow viewing of a video selection, selected by the user from one or more video selections, stored in memory. The computer or personal device of the user can either have the video selections pre-loaded into its memory or the selections can be downloaded or streamed from servers to provide the selected viewing of the video selected by the user on the display screen. Alternatively, various identifiable data streams can be selected from remote servers or computers (or from the user's computer/device's memory) which can be viewed on the user's display screen.

The present invention is an intuitive-feel, preferably touch-sensitive controller on the video screen used for display of the selected video or the controller is used by selecting a visual segment via mouse, touchpad, touchscreen, control buttons, etc. The controller is visual and has a visual segment corresponding to each of the video selections which can be viewed by the user. The device of the user will necessarily have a video screen display for showing various data packets or videos which can be viewed upon the use of the system and selection of the video to be seen by selecting the visual segment on the screen which is coupled via software to the video selection sought to be viewed.

In the preferred embodiment, the electronic device (desk top computer, lap top computer, pad or tablet, private data assistant, smart phone, web-enabled television or set-top box, etc.) will have loaded into its own memory or have instantly accessible (via streaming from a server, cloud, from another computer, etc.) a set of video signal selections or film clips, video streams, programs, etc. of potential interest to the viewer/user or other visually presentable media. Preferably, the present invention is intended for use as the functional interactive mechanism or manner for a user/viewer of a video magazine to browse and select which, from among several video articles or video clips of interest, to display and in what order of preference to display the same, on the display screen of the electronic device. Of course, the present invention can be a control and selection mechanism for other video segments, any audio-visual content and for games, college courses, too. Opening a media video signal or segment can open a game at a point of interest, a chapter in a book of text, a lecture in a course, too. In addition, the present invention can be adapted for use in connection with any set of data, in any form, e.g., books, advertising, product information, etc.

The invention relates to a geometrically-integrated, preferably touch-sensitive but, in any event, selectable, graphical user interface and display on the electronic, preferably pixilated screen of the device which can be used to select the video program of interest (with or without accompanying audio, of course) and to cause the same to be loaded, streamed, displayed or played for viewing (with conventional touch or other controls for play/pause, fast forward, fast rewind, etc.). Each of the available video signal selections are represented on the display screen as a different visual segment. The visual segments are integrated into some geometric pattern (circle, ring, rectangle, pyramid, polygon, undulating strip, etc. In the preferred embodiment, the selection and control system has a toroidal or circular shape accompanied with a visual pointer or selector (like a carnival wheel and pointer). Spaced about the outer edge of the circular shape are one or more arc-shaped, visual segments. The visual segments correspond, one to one, to the available video signal selections. The user is to use the graphical user interface and select one or more of the visual segments to call up for viewing on the display screen the video signal selection sought to be seen on the display screen. The visual segments of the controller are preferably color coded corresponding to a genre for the video. So, for example, red video segments of the controller could refer to sports-related video signal selections; green visual segments of the visual controller, located about the circular edge of the display, may correspond to video packets or video signal selections relating to nature; yellow visual segments may relate to video signal selections concerning current events or news; blue visual segments to video signal selections relating to topics of general information, and brown visual segments relate to video signal selections concerning business, purple to travel, etc. The arc length or degrees in a circle subtending by each visual segment preferably corresponds to the length in time (minutes and seconds) of the video signal selection associated therewith. That video signal selection, selected by the user when he selects one of the visual segments, will be streamed and seen on the display screen. The color, as mentioned, relates, preferably to the general subject matter of the video signal selection or data packet which will be displayed on the display screen if that segment is selected by the user. Preferably, the segment is also identified by text appearing on the visual segment, by Title, by author/director/photographer, by a number of stars “rating” the segment as judged by others, etc. The identification on the segment, by text or symbols (number of stars in a rating system, color intensity in an alternate rating system) appearing thereon, is meant to aid the viewer in the selection of which, among many, of the available set of video signal selections or programs or packets to view and in what order.

Collectively, the visual segments of the arc (the outer rim portion of a preferably visually and graphically integrated circular data management and control/selection “wheel”) equal the 360 degrees of the same. As mentioned, the number of degrees that each visual segment of the outer rim of the wheel extends or subtends is preferably proportional to the length of time for a total viewing of the video signal selection associated with that visual segment. So, for example, if ½ of an hour is devoted to sports and ¼ of an hour of the video “magazine” is devoted to business and another ¼ is devoted to travel, the visual and graphical selection and interactive “wheel” will have ½ or 180 degrees of the outer circumference of visual segment(s) in red; ¼ or 90 degrees of the visual segments in brown and the balance of the rim of the selection and control wheel or 90 degrees in the color purple. Superimposed on the arc-shaped colored visual segments will be further identifying text or symbols, for example, the title of the video piece, the author or creator, and the rating (in stars, a number or by intensity of the color of the visual segment) of the video signal selection as determined by one or more other prior viewers or a panel.

In use, the owner/user will use his finger on the touch sensitive screen (or other controller) to select one of the visual segments and thus one of the video signal selections from a set of the same. This can be accomplished by a simple rotation of the selection wheel so that the desired visual segment, in the example, the sports, business or travel segment, is aligned with a pointer on the display screen or the user can spin the wheel about its central axis, and by the speed and length of contact between the finger and display screen—determining the speed and degrees of rotation (much like spinning a wheel of chance at a carnival). Alternatively, the user can touch that segment on the visual screen (if a touch-screen sensitive is available) or otherwise select (by mouse, touchpad, buttons, etc.) to select the visual segment of interest and to thus activate the playing of the video signal selection which is associated with that visual segment of the control system. When selected, the visual segment causes the corresponding video signal selection to be displayed, streamed, and shown on the display screen. The alignment of the selected visual segment (by specific limited rotation of the visual segment or by random spinning) with the pointer will cause the video signal selection associated with that selected visual segment of the graphical and integrated visual display controller to commence playing on the display screen. Once the screen starts to display the selected of the video signal selections, the selection and control wheel is removed from sight or can be minimized and located in a corner of the video screen for later use). Once the video signal selection (from a set of the same) is displaying on the display screen, video control “buttons” on the screen or other controller will control the video, e.g., pause, stop, play, forward, rewind, fast forward and fast rewind, etc.

Alternatively, of course, the data management and control/selection device is not limited to a wheel or circular shape but, rather, can be any other visually integrated geometric shape, e.g., a diamond, a rectangle, an ellipse, pyramid, polygon, etc. even a spiral, continuous strip, undulating set of segments formed into a strip like that visually shown in CandyLand board game, etc. The constant, however, is that a set of video signal selections are capable of being selected by selecting the visual segment associated therewith. The video signal selections, of course, can be accompanied or not with audio. The corresponding visual segments can be individually selected (by touch or other system controller) and the visual segments of the display preferably correspond in size, color, length, other physical characteristics, etc. to the length of time for a full viewing of the video signal selection. Furthermore, the color coding of the displayed visual segments corresponds to a genre of the associated video signal selection.

The present invention is intended, in its preferred embodiment, to be useful as a controller and visual selection device for a video magazine, providing the viewer with tremendous flexibility to select from a set of different video signal selections which specific video selection, based on genre, author, title, length of segment, etc. to view, to view first, to view in the user's preferred order or not to view. In this manner, the present invention provides the user with the flexibility of selecting video signal selections of interest for viewing or not, much like a person can select in a conventional magazine which articles to first select for reading, based on interest, subject matter, length, author, etc.

As mentioned, the preferred use of the present invention relates to a general interest, multimedia and/or set of video clips or a video-based segmented magazine providing the viewer/“reader” with the ability, much like that present in any traditional paper and ink magazine to select by viewing title, genre, author, length of article, etc. by a review of the Table of Contents. The data management and control/selection device of the present invention, is powered by suitable software and allows selected viewing of the video signal selected from among the video programming or complete set of video signal selections “on call” (resident memory or in a “cloud” on dedicated servers, etc.). The visually and graphically integrated controller provided by the present invention provides a wholly intuitive and basic Table of Contents for this video magazine such that the viewer, upon demand, can select which of the video signal selections to view and in what order by merely selecting the corresponding visual segment then on the display screen.

As another potential feature of the present invention, the circular or other geometric shape for the graphical interface can be provided with a simple touch-sensitive button or another mechanism which can be used for selecting a visual segment by the user/viewer so as to re-arrange how content in the data base is displayed on the rim or other portion of the wheel-like graphical segment interface. The system can have, for example, a mechanism, like a selectable button on the touch-sensitive screen, which allows the user to select the display of the data, whether video segments, games, music videos, etc. by alphabetical order of Title, by Author, length of segment (longest first or shortest first), genre, topic, rating, etc. Another set of interactive button(s) or selectable mechanism will allow the user/viewer to desirably share the selected video or other segment with others by email (opening up the needed dialog box for completion); by use of Twitter; by Facebook, or other social media sharing sites and mechanisms.

In an alternate embodiment, the present invention can have a secondary set of one or more visual segments (circles within circles or toroids within toroids) which allow the user to obtain further details or information relating to the primary video selection. In the preferred embodiment, the visual segments are integrated into a toroid or circle. In the alternate embodiment allowing for the user to obtain further and more “in depth” video information relating to the video signal selections, the toroid is itself surrounded, visually, with a further toroid, and with appropriate shading, the toroid within the toroid appears three dimensional. When the secondary or surrounding circle or toroid is selected, the user will be taken to further video signal selection(s) or text of interest and related to the primary topic of the visual segment. The concept sought to be accomplished here is that the user could touch or “pinch” the screen to access the circles within circles, toroids within toroids, or dials within the dials—allowing the creator and publisher of the video magazine the ability to “scale” the depth of the topics covered in the magazine as much as desired. So, for example, it may be that a publisher distributes a video magazine meant to entertain and educate children. The primary visual segments can provide the video signal selections for selected viewing. The surrounding circles or toroidal segments, when they are selected, may provide the same video signal selection on a different level, say, for young adults or the secondary surrounding segments could provide the parent with additional educational activities to be used with the child, before or after the primary video signal selection is viewed. Or, maybe, the magazine is a travel magazine and the selected video signal selection (selected by a controller selecting an associated visual segment associated with the video signal selection of interest) and the primary video signal selection displays a very general overview of a country of interest. The surrounding visual segments, corresponding to additional “in depth” information relating to the country of interest, may display video signal selections (when the visual segments corresponding thereto are selected) to specific sights to see, to weather conditions based on time of year, to hotels and pricing, to Visa requirements, etc.

Another concept sought to be provided by an aspect of the present invention would be the provision of one or more, preferably, two visual-looking “handles” on the side of the integrated, graphical video magazine controller, that when touched, would enable different menus, time/subject/director/etc. . . . One handle could be for providing further depth of interest while the opposed or other handle could allow for options to share the video signal selections with others via social media mechanisms, for example, twitter/facebook/email, etc.

Important to the functionality and intuitive use of the present invention are a preview aspect of the selected video signal selection and the instant availability of previewing other of the available video signal selections. When one of the visual segments is selected, the corresponding video signal selection will start to be displayed on the display screen. In addition, according to the preferred embodiment of the present invention, after selection of a visual segment and the corresponding video signal selection by the user on the main menu “wheel,” several of the other of the set of video signal selections are instantly also available for a short preview. When the main part of the display screen shows the selected video signal selection, the balance of the screen can be used for displaying a still shot, a photo, other identifying information relating to adjacent or related (or unrelated) video signal selections from the same publication. If one of those other video signal selections is desired for immediate viewing, the user can merely select that still shot, photo, segment, etc. which will preferably cease the streaming of the original video signal selection and cause the new selection to commence being streamed. This is accomplished by selecting the video segment of current immediate interest from among several whose still shots are located on the main display screen, preferably below or off to a side of the first selected video segment. That now-selected video segment will be previewed by either stopping the main, initially selected video segment and allowing the second video segment to be displayed for a few moments or seconds or by having both video signal selections stream at the same time. Preferably and alternatively, the second video signal selection can be displayed in the primary location of display on the display screen with the original (and now no longer of primary interest) video signal selection being moved into place below or to the side or the primary viewing area of the display screen. In effect, selecting from the “still shots” will cause the associated video signal selections to instantly swap positions with the originally selected video signal selections (which is preferably stopped from display but “held” in play position so that if it is re-selected, it will re-commence play and display from where it left off by swapping back into the main position of display on the display screen. Thus, two video signal selections can be swapped, from “on call” preview position to streaming on the primary location of the display screen. This provides exceptional versatility of control to the user and the controller of the present invention. The preview of various video signal selections (or other media or data available selected items) is meant to be a seamless, continuous and fluid delivery of the media, preferably one or more video signal selections are available within a video magazine, provided to the user of the electronic device.

### DESCRIPTION OF THE PRIOR ART

A computer mouse is available for use with desk top and lap tops for selecting (by clicking and double clicking) a linked item of data for viewing. In addition, other cursor selecting mechanisms (track balls, joy sticks, arrows, etc.) are available, all for enabling the user to select a linked item of data for selective display. Generally, the user will view a list of one or more of potential data items of interest, move the cursor over or under the item of primary interest, and select the item for viewing. The electronics and software then “call up” and display the selected item on the display screen.

In today's pads, laptops, notebooks, and smart phones, a cursor is movable by use of a finger on the touch sensitive display screen to move the cursor and then a simple single or double tap will “call up” and display on the screen the selected data article or site of interest. Similarly, in today's now available electronic and smart pads, laptops, and tablet devices, the swipe or movement of one or more fingers, a tap, a button, etc. can result in the selection of an item of interest for display on the screen. Some of these selections can be video streams, live video feeds, etc. Some of the video streams are stored on the memory of the device, some are stored in a “cloud” some on servers, etc. These devices are powered by controllers and software that “read” the touch-sensitive screen or mechanical controller (touchpad, joystick, buttons, etc.) and causes the selected data of interest to be displayed.

The present invention preferably relies on a touch screen display for selection of the video signal selection or video or “film clip” of interest from a stored in memory set of such video signal selections. The present invention is preferably useful with a touch screen display device but other interactive and selecting mechanisms, now in existence or to be created in the future may be useful, too, to operate and select the video signal selection from among an available set of the same to display the same on the display screen in response to an act of selection by the user.

Apple, Inc. of Cupertino, Calif. has made and sold an I-Pod device for selective display (visually and for hearing) of music and music videos. The electronic device has loaded into memory therein, preferably from the Apple Store, one or more musical compositions and videos associated therewith (comprising an available set of video signal selections) any one or more of which can be specified to be sensed, in an order or randomly, for immediate viewing and listening. The user of an I-Pod device generally interacts with a physical wheel-like mechanism which coordinates via software to a list of available data streams (music and video) stored in memory. In use, the display screen will have a listing of the stored compositions. The user can select one for instant play and enjoyment by using his/her finger on the physical rotation-like wheel, in this case a wheel-like device on the front face of the device, not on the display screen, such that movement around the edge of the wheel will correspondingly move the cursor up or down, or side to side (in the case of volume adjustment) to iterate through the potential selections. When the cursor is upon the selection of choice, the user can depress a “select” button and that will then cause the device to display and play the musical composition. Alternatively, newer versions of the I-Pod music player employ touch sensitive display screens which allow the user to flip through, by swiping his/her finger, across a set of, for example, album covers, to view available and pre-stored albums and songs, and then to select, by tapping thereon with a finger, the album or single song of choice. That will cause the selection to be displayed or played on the screen and/or played through a speaker of the device.

### SUMMARY OF THE INVENTION

The present invention is a new data management control and selection mechanism preferably for use with a touch screen electronic data storage and display device. The graphical user interface and data control and selection mechanism can be used with smart phones, with electronic pads, tablets, laptops, desktop computers, set-top boxes connected to monitors, etc. i.e., it can be used in connection with any content distribution system connected directly or indirectly to a) a memory holding one or more of the available video signal selections and b) a display screen for viewing the video signal selection selected by the user from the available set of video signal selections. While preferably intended to be used with a lap top, a pad, or other personal computer or smart phone, it will be appreciated that the data management control and selection system can also be implemented as a user interface for a larger playback or video media playback device, such as the more traditional family style home media center. For this purpose, as will be appreciated, the touch screen aspect for selection of the video or other data signal selection would likely be done by remote control, by hand gesture, by voice, etc.

Preferably, the embodiment of the data management control and selection system for media, preferably video signal selections, is a visually integrated, graphical interface, preferably a round, circular or toroidal (doughnut) shape, like a wheel. In effect, the wheel serves as a Menu Wheel for selection one or more of a set of stored data packets or video signal selections for display. The outside or rim of the wheel-like graphical display is comprised of a set of adjacent arc-shaped visual segments all of which together, preferably, form the integrated and thus complete 360 degrees of the circular graphical display. The user can rotate the wheel about its center (by touching the touch sensitive display and “moving” the wheel about its center) and thereby rotate the visual segments forming the outside rim so that any segment is aligned with a stationary pointer (like a wheel of chance at a carnival). When the visual segment is aligned with the pointer (or otherwise selected) the corresponding video signal selection for that visual segment is called up from memory and thus activated. The screen display will then drop off the Menu Wheel and start to stream and display the moving images of the selected video signal selection corresponding to the selected arc-shaped visual segment of the wheel.

As mentioned, the length of the arc defined by each visual segment, for each individual video signal selection, corresponds, preferably to the length of the video or film clip which will be displayed if that program is selected and fully played to its conclusion. This allows the viewer to decide, by visual selection first from among the visual segments of the Menu Wheel, then by rotation of the displayed wheel on the display to align the same with the stationary pointer or by tapping, touching, other mechanical selection and/or clicking, physical yet non-touching gestures (X-Box Kinect or other game or video/data providing system, etc.) until one visual segment corresponding to a memory-stored video signal selection is selected. The video signal selection is then available for current viewing.

So, for example, if the viewer/user has only 5 minutes of time for viewing, he may select a visual segment corresponding to a video signal selection from among a set of stored video signal selections. The visual segments are shown on the display or Menu wheel. The user may thus select the visual segment corresponding to a 5 minute film clip, or he may select a 2 minute video clip followed by a 3 minute clip, or, if desired, the viewer can commence a 30 minute clip, see 5 minutes and view the balance at a later time. However, according to the preferred embodiment of the present invention, the viewable length of time for viewing the entire available video signal selection will be represented by the arc subtended by the visual segment of the Menu Wheel. It is believed that use of the present invention will greatly facilitate the selection process and the overall enjoyment of the available set of video signal selections. A highly interesting, entertaining video-based and educational magazine is thus made possible by the present invention—a visually integrated, highly intuitive, information-providing video signal selection and control system. It is primarily based on association of a visual segment on the display screen with a video signal selection available from a set of such selections stored in memory.

In an embodiment of the invention, as a selected, for example, video signal selection (after selection of the visual segment corresponding thereto) is playing for the viewer, the menu, if still visible say in a smaller version in a corner of the display screen, will show the arc-shaped visual segment darken in its color as a function of the time played and yet to be played of the video signal selection. This will help the viewer know at all times at what point he is at along the overall length of the video signal selection being played or viewed for a given video signal selection. Then, if the viewing is paused or stopped, for any reason, the darkened color area of the visual segment (or a moving line can be used from one end of the segment to the other) adjacent to the still light relative area will alert the user/viewer as to what portion or section of the video signal selection has been viewed and what remaining portion has not yet been viewed. The user can select only for viewing the unviewed section of the video signal selection or the viewer can review any or all of the previously viewed section of the video signal selection.

Alternatively, another feature of the present invention contemplates that the visual segments, for example, of the video magazine (corresponding to the video signal selections) will be listed in some order (alphabetic, by length of video to be played, by subject matter, rating, etc.) and a preferably horizontal graphical line, preferably in two colors, adjacent thereto, with the overall length of the line representing the overall length of the video segment and the first color or section of the line depicting, relatively, the portion, if at all, of the video signal selection already viewed with the balance or another color of the line showing that portion of the video signal selection not yet displayed or viewed by the user/viewer. Alternatively, the visual segment or line can be a single color or graphical representation and the portion of the segment seen visually distinct from the balance of the line representing the portion of the video signal selection not yet viewed. So, for example, if there are two video segments in a video magazine, the visual display for enabling use and control of the video signal selections could show:

[symbol]

[symbol]

This instantly, intuitive, and easily shows the user: that the Belize video signal selection segment is authored by Coppola and that its overall length is shorter than the total length for viewing of the video signal selection entitled: Rwanda, by Herzog. However, the visual display also shows that more of the Belize video signal selection has already been viewed in total minutes and seconds than the viewed video signal selection for the article or film clip entitled: Rwanda. The visual and horizontal lines are time lines of video signal selections and reflect the minutes and seconds already viewed and the balance, to be viewed, if desired. In this case, for ease of illustration in a conventional text-based document, the time line is comprised of simple underscoring and adjacent “equal” signs with a “/” indicating the separation between that which has been viewed and that which remains to be viewed, but in an electronic and multi-color display screen, the time line can be color coded and of different intensity of color to depict that which has been viewed versus that which remains to be viewed.

Also, the color of the visual segments located about the virtual display wheel are intended, too, to provide some information to the viewer as to what is the nature of the content of the video signal selection corresponding thereto. So, for example, if the overall selections are of general interest to the public, like a general magazine in the paper and ink world, Time Magazine, for example, then the display wheel may have its segments relating to politics in striped blue and red; its segment on money in green; that relating to celebrities, bearing a background of white stars on a blue sky; etc. Thus, the color of the segment will also aid the user in making his/her video signal selection(s) for determining that which is desirably viewed. The length in degrees of the arc-shaped visual segments and the color of the same, along with other identifying information carried by text or symbols thereon, e.g., title of piece, author, length of time of video segment, genre, rating, etc. will aid the viewer in making his selection of the video signal selections to view from among the set of video signal selections. This invention, similar to the Table of Contents in a traditional print and paper hard copy magazine, allows and maximizes the utility of the visual magazine format. The data management and selection/control mechanism disclosed herein is highly attractive, intuitive to use, and very functional for its intended purpose.

An important aspect of the graphical interface for data control and selection relates to the “elevator up” feature of the video display screen when a desired arc-shaped visual segment on the Menu Wheel is selected. While the device then displays the selected video signal selection (corresponding to the selected visual segment) across the majority of the available display screen, the bottom portion of the same display screen will instantly become a preview section for the other or non-selected video signal selections which are stored in memory and available for that “magazine.” This feature provides a still “shot” of the other video signal selections along with identifying information for those selections to be displayed along the bottom located preview pane or section. Those video signal selections carried in the preview section, can be viewed, too, while the main video segment is playing in the main section of the display screen, in the desired 16:9 aspect ratio. Then, if desired while the main and originally selected video signal selection is being displayed, the user/viewer may desire to view another of the available video signal selections, as prompted by the view of the same along the preview pane or section of the display screen. This is accomplished by a simple touch or tap (or even by a voice command or a mere “in the air” physical gesture) on that “still shot” or preview screen portion which will cause that video signal selection to either play along with the video signal selection in the main display screen, or the two video signal selections can switch places so that the originally selected video signal selections becomes part of the preview screen section of the display screen and the now, newly-selected preview video signal selection becomes the video signal selection of primary interest and prominence on the display screen. Alternatively, one video signal selection will stop playing when another is newly selected until and unless the first video signal selection is caused to be recommenced by appropriate selection. One or more videos, preferably, however just one, will be viewable by the user either in the main display portion of the screen or on the preview pane portion.

In an alternate embodiment of the present invention, one or more graphical “handles” are provided around the Menu Wheel. This allows the user, by tapping or otherwise selecting the handle to obtain more information relating to the displayed video signal selection. In an alternate embodiment, the Menu Wheel is provided with surrounding visual segments, providing a three-dimensional (by coloration) look to the visual segments. The surrounding visual segments can, when selected by the controller, provide additional video signal selections related to the primary or inside-located video signal selection of the visual segment. This allows the controller to provide a depth of content aspect depending upon the degree of interest of the viewer/user, the age, abilities, etc.

### BRIEF DESCRIPTION OF THE FIGURES AND SCREEN SHOTS OF A WORKING PROTOTYPE

FIG. 1 is a view of the preferred, circular, graphical user interface for a video-based magazine containing a set of video signal selections, as seen on a touch-sensitive screen of an electronic video display device and

FIG. 2 is a view of the representative and video signal selected by use of the visual segment corresponding and associated with the video signal entitled “Theo and his Amazing Machines,” in preferred aspect ratio of 16:9 and also showing a control bar for the playing of the video as well as other available video signal selections (as stored in memory) located below the then-viewable video signal selection, with other available video signal selections displayed on the below-located Menu Bar—horizontally scrollable to display even more and available video signal selections for viewing.

FIG. 3 is a simplified and somewhat crude, graphical representation of the inventive embodiment of the present invention wherein the main visual segment is surrounded with another visual segment and the segments show three dimensionality. This feature allows for depth or understanding and/or additional information relating to the principal video signal selection, as described hereinafter.

FIG. 4 is a view of the menu wheel of the present invention with enhanced capability, as shown by the paddles or handles surrounding the main visual segments. This feature, too, is described hereinafter.

The other Figures shown in the Drawings relate to the preferred graphical “look” of a prototype system, named, SLINGSHOT, and illustrate and describe, as a Power Point-like demonstration, various features and characteristics of the invention. In this connection, the system is illustrated as a software application for use on an Apple iPad and shows various available video signal selections, with the primary and intitially selected such selection being entitled: Theo and His Amazing Machines.

Also attached is an Appendix of Slingshot Functions—a summary listing of features and preferred characteristics of the prototype Slingshot system.

### DETAILED DESCRIPTION OF THE PREFERRED EMBODIMENT, THE FIGURES AND THE INVENTION

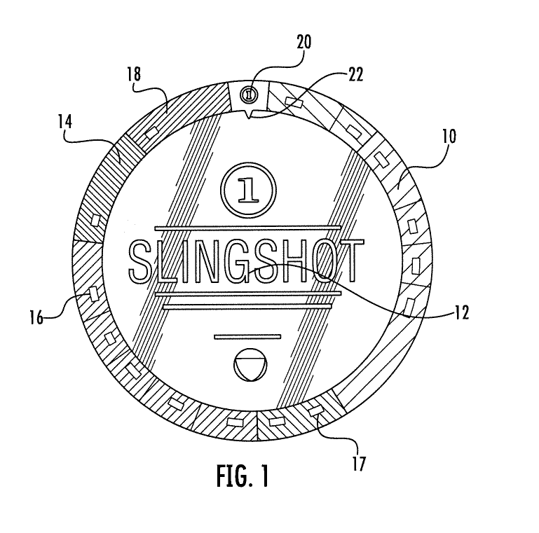

FIG. 1 shows the preferred form of the invention, a data management control and selection system, primarily for video signal selections. The graphical interface, in the preferred embodiment, comprises a toroidal or circular shape on the screen display or monitor. According to the preferred embodiment of the invention, the graphical interface is usable on a touch-sensitive display screen which allows for the user to select an item on the circular graphical interface and, then, the item (a video signal selection) will be streamed or “play” and be displayed for viewing on the electronic display screen. The present invention can be used for selecting from among a huge variety of selections of various data or film, video in digital form, stored on the device's memory, on servers, in the “cloud” etc. The function of the present invention is to enable a user/viewer to select for viewing and display on an electronic screen, for example, video clips, movies, cartoons, music videos, college courses, video “articles” with or without text and/or screen shots for a video magazine, food menus, selectors of appliances on the Internet, selection of any one or more items stored as data on or in connection with an electronic display device. Preferably, however, the present invention is a graphical and interactive “table of contents” and selector for a video-based magazine.

According to the preferred embodiment of the invention, the data management control and selector, is a graphical interface, intended to be used for a video magazine and allows a user to browse content in the video magazine and select one, more and possibly all of the video signal selections to be viewed and in what order of the magazine. The video segment(s) (and, of course, accompanying audio) content of the magazine can be downloaded, streamed onto the electronic device or maintained in “the cloud” on servers, etc. until the user selects that video signal selection and desirably views the same. Thus, a set of video signal selections is stored in computer memory and the user is expected to use the invention to facilitate the selection and play of the desired individual video signal selection from among those available. Then, upon selection by the user, by use of the graphical interface, the electronic device will “play” the video signal selection until it is paused, stopped, rewound, fast forwarded, and/or completion of the same. Suitable graphical and user interactive controls are provided, again, preferably on the touch-sensitive screen for playing the video signal selection as desired.

According to the preferred embodiment, the graphical interface on the touch sensitive screen, a data management system for control and selection of video signal selections is preferably, as shown in FIG. 1, a round geometric shape 10. Here, the geometric shape is a toroidal shape but, of course, the shape can be a complete circle; a square, rectangle, a hollow of a square or rectangle, a trapezoid, a polygon, and, even an undulated line, spiral, squiggle, series of loops, etc. Any substantially integrated geometric shape extending partially on the display screen can be used but the preferred embodiment is a toroidal or ring shape, a simple, relatively thin perimeter edge, of reasonable thickness extending from the absolute perimeter of the circle it circumscribes, towards the center of the circle 12. The outer rim 14, as can be seen, is of a thickness extending towards the center 12 of the round geometric shape 10. The outer rim 14, as can be seen, is segmented by at least one, preferable three or more, arc-shaped visual segments 16 such that all of the arc-shaped visual segments form the rim 14 about the center 12. The arc-shaped visual segments 16, are preferably of a length in degrees or arc-length, corresponding to the overall length of the video signal selection to which it corresponds. So, for example, as seen in FIG. 1, a short video signal selection is represented by a relatively short, in arc-length and degrees, arc-shaped visual segment 17 while a relatively longer video signal selection, selectable and associated with a different and longer arc-shaped visual segment 18, is similarly shown. Clearly, the sum of all arc-shaped visual segments 16 will be about 360 degrees of the perimeter of the toroid although some arc-shape/degrees of the rim will be reserved for the pointer segment 20. Of course, an entire blank visual segment can be provided, too, to complete the degrees of the visual segments to form a complete toroid.

As an alternative to locating and arranging the various video segments around the rim 14 according to the associated length of video signal selections, the video magazine provided to the user/viewer can be presented on the graphical interface in a Table of Contents manner with the order of the video segments, as they appear clockwise around the menu wheel in the order presented by the Editors of the video magazine, but with the length of the visual signal selections still preferably shown as corresponding to the length of the arc segments or arc-degrees around the circular menu wheel.

A pointer segment 20 preferably located at the top or right side of the round geometric shape or device 10 can “fill in” the arc shaped visual segments 16, to the extent they do not fill in or extend around the rim 14. The pointer can also be outside or separate from the outside rim 14. The pointer segment 20 has an inwardly directed pointer element 22 much like the pointer of a rotatable wheel at a carnival event.

In the preferred embodiment, the arc-shaped visual segments 16 are provided with identifying text or symbols (stars, for example) which will aid the user in identifying which, as among the various video signal selections, to select or in what order to view the same. So, for example, the title of the video signal selection, its author, its length of time of play, etc. and/or a rating, by number, 1-10 or number of stars, etc. can be shown and displayed directly upon the various arc-shaped visual segments of the graphical, interactive controller. This information, too, will aid in the selection process by the user.

In addition, also according to the preferred embodiment, the arc-shaped segments are colored and color-coded so that the user/viewer can use the color of the arc-shaped segments to facilitate the selection as among all potential video signal selections. So, for example, green as the background for the arc-shaped segments 16 can relate to a video clip or video signal selection relating to business, red to sports, brown to news, red and white arc-shaped stripes to politics, blue and white stars relating to celebrities, etc. The pointer segment 20 and the pointer element 22 should be a distinct color so as not to confuse the user and so that he/she can easily determine which of the arc-shaped segments has been aligned therewith. This is one method of selecting the visual segment, which then corresponds to the associated video signal selection (form among many available). The user will align the visual segment with the pointer element (by finger touching of the outer rim 14 or rotation or spinning of the round geometric shape 10 about its center 12). The movement of the user's finger can visually rotate on the display screen the geometric shape 10, about its center 12, so that a selected arc-shaped visual segment 16 is aligned with the pointer element 22 of the pointer segment 20.

Alternatively, a tap or double tap of the arc shaped visual segment 16 of interest to the user/viewer will result in the alignment (by suitable software) of that visual segment with the pointer element 22 of the pointer arc-shaped segment 20. In any event, once a visual segment is selected by relative rotation of the round geometric shape 10 about its center 12 or by tapping (or if the screen is not touch sensitive, by some other electro/mechanical selection mechanism, e.g., a cursor and selector button) it is intended that the video signal selection associated with the visual segment so selected be displayed and viewable on the display screen. In the preferred embodiment, the video signal selection will replace and be directly superimposed on the display screen over the round geometric circle 10 of the controller but it is also contemplated that the data management control/selection system be merely reduced in size and located in a corner of the display screen, too.

As an alternative and according to the preferred embodiment, upon selection of a video signal selection, by spinning, turning, tapping or otherwise selecting the arc-shaped visual segment associated with the video signal selection of interest for viewing, the center section of the round geometric shape 10 can show a preview (a few seconds) of the selected video signal selection. Then, after the few seconds are displayed, the entire display screen can carry and display the video signal selection unless the user/viewer selects, by manual spinning on the touch screen or otherwise selecting another arc-shaped visual segment, in which case the second video signal selection will be previewed.

As another embodiment of the present invention, the tapping on the touch screen of the electronic device, on the right side of the round geometric shape will “advance” or rotate the rim clockwise with respect to the pointer segment and the pointer element, so that the rim turns with the next arc-shaped visual segment aligned with the pointer element 22 for preview and possible viewing of the next video signal selection whereas tapping on the left side of the round geometric shape can cause the round geometric shape 10, in effect a Menu Wheel, to rotate counter-clockwise so that the video signal selection associated with the arc shaped segment 16, just before the last played video signal selection is aligned with the pointer element 22 for preview and playing.

As another embodiment of the present invention, one or more other graphical interfaces are provided for advancing or retracing the Menu Wheel with respect to the pointer segment and pointer element. So, for example, a right facing arrow or an advancing arrow could be displayed on the screen to the right of the Menu Wheel or round geometric shape 10 which, when tapped or otherwise selected, will advance or rotate the Menu Wheel and thus the arc-shaped visual segments and the associated video signal selections clockwise while a left-facing or retracing arrow could be located to the left of the round geometric shape 10 for use by the user in spinning or rotating the Menu Wheel in the counter clockwise direction for preview and possible playing of the prior arc-shaped visual segment and corresponding video signal selection. Each visual segment is associated with one video signal selection so that selection of a visual segment by the user will start the playing of the associated video signal selection on the display screen.

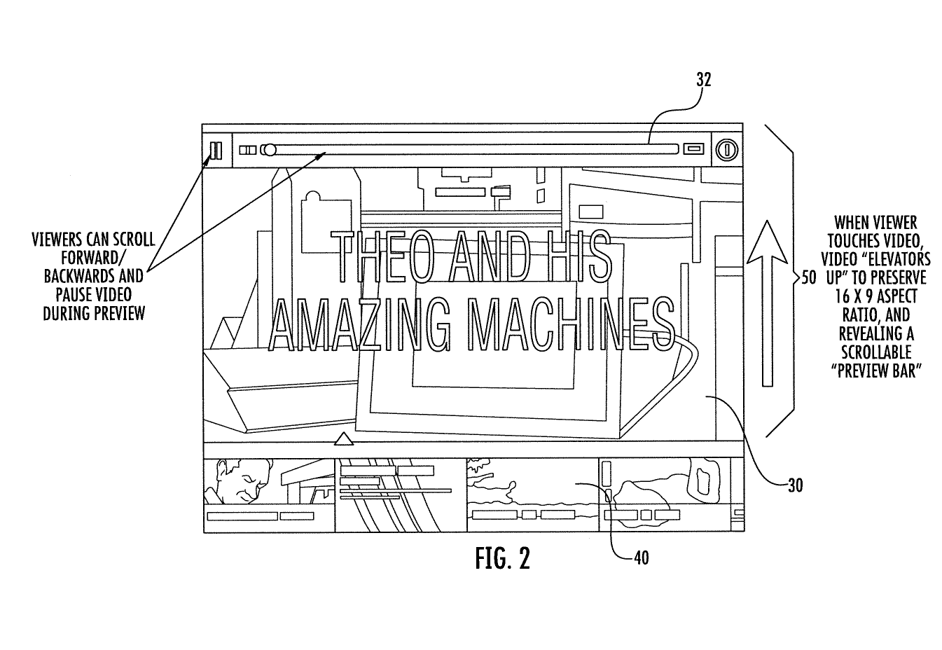

As shown in FIG. 2, once the user has selected an arc-shaped visual segment 16 and the corresponding video signal selection for playing, after the few seconds of preview has been played in the center of the rim 14, substantially the entire display screen is intended to be occupied by the video signal selection of interest. In the illustrated example, the selected video signal selection of interest is entitled: Theo and His Amazing Machines. It will play and be displayed on the display screen, unless another video signal selection is selected by selecting another visual segment of the menu wheel. Alternatively, as can be seen at the top of the display screen 30, a control bar 32 can also be provided. This will allow, by touch sensitivity (or other suitable controls) the video signal selection to be paused and then played, rewound, and/or forwarded and will also indicate the time of the entire video segment and how much time is left to complete the video signal selection and how much time has elapsed from the beginning of the playing of the video signal selection. This is quite conventional, in function and look.

As an embodiment to the present invention, once a visual segment is selected, the video signal so selected will first play in a preview mode, but after preview, playing of the video signal selection is provided on substantially the full display screen but preferably at a 16:9 aspect ratio. The video signal selection on the display screen extends preferably over the entirety of the display screen, but for a) the control bar 32 (pause, stop, forward, rewind, etc.—which control bar can become hidden until a control motion or button activated) and b) a portion of the display screen displaying for potential use a small version of the menu wheel. As can be seen in FIG. 2, below the display area 50 can be a preview, horizontally arranged bar 40. It can show one or more single screen shots, a brief “trailer” of the available video signal selection, a title screen, or other information for the other available video signal selections. The information provided therewith can be titles, authors, genre by color (not shown) and length of the video signal selection. Tapping or otherwise selecting those visual segments or screen shots/photos, etc. from the bar 40 will cause that selected visual segment and the associated video signal selection to be switched into and played on the principal display area 50 and the prior displayed and playing video signal selection previously playing or displayed in the principal display area 50 will be “swapped” down into the horizontally arranged preview bar 40. Thus, change from one video signal selection to another video signal selection can be easily and quickly accomplished, without necessarily having to go back to the menu wheel. Alternatively, tapping or otherwise selecting one of the video signal selections on the horizontally arranged bar 40 will cause that video signal selection to be previewed, for a few seconds of its length, without placing it into the display area 50 but, rather, by maintaining the video signal selection within the horizontal preview bar 40. While previewing the newly selected video signal selection within the preview bar 40, preferably the video signal selection within the main part of the display screen can either continue to play, play at a slower speed, or cease playing. Alternatively, the originally selected video signal selection and the newly selected video signal selection can change locations on the video display screen.

As another embodiment of the present invention, the horizontally arranged bar 40 can be horizontally scrollable (and controlled by a system controller mechanism—touch surface, buttons, mouse, etc.) to reveal the other video signal selections of possible interest, all while the prior selected video signal selection is displayed in the main display screen area 50. A tapping or selection of one of the previewed (screen shots, identifying information) video segments within the horizontally arranged bar 40 will cause it to “elevator” up into the main area of the display screen 50. Correspondingly, the video signal selection previously in the main area 50 of the display screen will transfer to the preview scroll or horizontal bar area 40. This feature, however, “elevator up,” is also suited for description of the result the user obtains when touching or selecting the initial visual segment to be viewed on the Menu Wheel, i.e., touching or selecting the visual segment to be viewed will cause that associated video signal selection to replace the Menu Wheel's prominence on the display screen (entirely replace or shift it to a reduced size in a corner, for example) with one or more of the other available for viewing video signal selections to be located beneath the display of the selected video signal selection in a horizontally arranged set of video segments which can be previewed on a “preview pane” section of the overall display screen. The selection of the main video signal selection will cause the same to be viewable or displayed in the preferred aspect ration of 16:9 while revealing the preview scroll of other video segments at the bottom (or top, side, etc.) of the display screen. In addition, as mentioned, the selection of one video signal selection for viewing/display will also cause a video navigational bar (with pause, play, rewind, forward, buttons or control mechanism) to appear (permanently or upon a command signal, e.g., a selection of a controller) for potential use.

As another embodiment of the present invention, touching or tapping or otherwise selecting any video signal selection in the horizontally arranged preview bar 40 will preview it for a short time, about 10 seconds, while pausing (or playing, muting the audio and possibly fading the video) of the video signal selection shown in the display screen 50. Substantially at all times while viewing the Menu Wheel, the then played video signal selection and/or the preview-available video signal selections below the played/displayed video segment, i.e., even during visual browsing to determine which video signal selection most appeals to the viewer/user, video signal selections may be played to encourage viewing, rather than mere still shots. There are substantially no static times i.e., extended time periods where no video signal selection is being viewed or displayed.

At any time that a video signal selection is being previewed in the horizontally arranged bar 40, the user can use the touch sensitive screen (or another selecting device or mechanism) as, for example, by “expanding the forefinger from the thumb, while in contact with the then being previewed video signal selection in the horizontally arranged bar 40 and that will cause the previewed video signal selection to exchange locations with the video segment in the main video display screen 50, such that the previewed (and now more desirable) video signal selection is on the main display screen 50, in the desired 16:9 aspect ratio, and the prior video signal selection displayed thereon moved into the horizontally arranged preview bar 40.

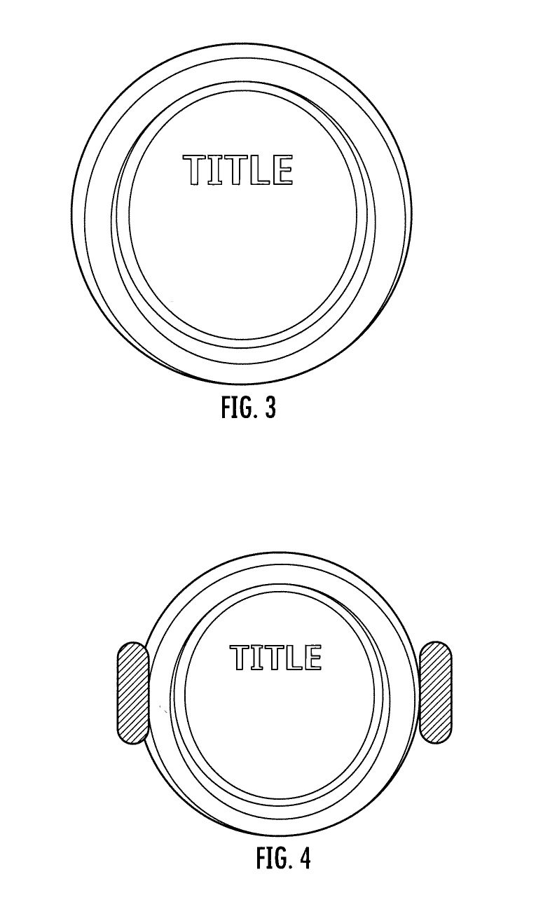

According to other aspects of the present invention, the graphically integrated visual segments for the video signal selections can be surrounded with further and larger or smaller similar geometric shapes. This is roughly shown in FIG. 3. Thus, the menu wheel can have one or more additional rings encircling it with increasing diameter for each surrounding ring or, alternatively, can have smaller diameter segments inscribed within the main ring. Those rings can have the same basic color and proportional length as the visual segment which it surrounds (or is inscribed within) yet is visually distinct, as, for example, having a solid separating perimeter line, cross hatching, and/or the same basic color but a different intensity (hue and tint) to the color of the visual segment. These surrounding (or inscribed) visual segments are additional selection options for use by the viewer. They can provide, for example, if selected, further details relating to the video signal selection. So, for example, if the main topic of the video signal selection for a particular associated visual segment relates to sports, maybe, for example, a video selection concerning the New York Knicks, the first, greater in diameter, surrounding ring segment may be a further video signal selection relating to one or more of the individual players, maybe another visual segment relating to the yearly New York Knick video highlights, maybe another visual segment surrounding that visual ring concerning the New York Knicks allows access to a video signal selection showing selections of a Championship season of the New York Knicks (1970), etc. The surrounding (or inscribed) rings or visual segments allow the publisher to provide additional levels of depth of understanding and interest to the main or primary video signal selection. Also, the surrounding visual segments, upon selection, may allow for the user to be immediately transferred to a website where merchandise or services are available which, again, preferably relate to the main video signal selection. Here, in this example, maybe one surrounding visual segment provides the user with instant purchase options for New York Knick merchandise or tickets to future games, etc.

Alternatively, the encircling (or in-circling) ring segments about the menu wheel allow for various scaling by the publisher, for example, the same topic could be presented in a 20 minute version, a 10 minute or even a 3 minute capsule version. Or the various rings allow for differences in audio language with a constant video being provided. Or the various rings can provide the user with the ability to select age appropriate material, visually and audibly. So, for example, a video signal selection about Club Med vacations might have the main video signal selection showing the physical facilities, while one ring for selection might be dedicated to showing the features of Club Med for single woman and another ring for selection might be associated with activities for families with young children, etc. One outer ring could present the costs and another might be a direct active link to the website for making reservations. The rings can be shades or properly drawn to show three dimensionality to the viewer/user.

In another embodiment (See FIG. 4) of the invention, the circular toroid of visually integrated segments is provided with graphic equivalents of “handles”—a pair of opposed selectable visual ring segments or locations surrounding the outside of the visual segments. A User activation via touch screen or other selection device (mouse, cursor, touchpad, etc.) allows one or the other handle to be selected. The two opposed visual segments, surrounding the visual segments that represent the video signal selections of the menu wheel, are in visual effect, “handles” on the side of the menu wheel and when selected function so that when touched or otherwise selected, different but preferably related menus, information, time/subject/director/etc. would be viewable to the user. One handle allows for zooming in and out for information while the other handle could pop up onto the display screen one or more “sharing” choices—twitter/facebook/email etc. These handles roughly correspond to the paddles of a steering wheel of an automobile and provide the user with choices for use of the device. It could be an increase in size, volume, information, point of view, etc. for the displayed video signal selection, for examples. One visual form of such handles is roughly shown in FIG. 4.

The attached Appendix summarily describes and identifies other likely features of the invention which can be incorporated, depending upon usage and desirability. Also, the other pictures of the drawings show the utility of the invention and manner by which the features operate individually and with respect to one another.

As can be appreciated, the present invention is a graphical, preferably touch sensitive user interface for data management, selection and control, and preferably is useful in connection with a video magazine. The invention allows a user to browse through video signal selections held on a memory device or broadcast live, much like a user currently can browse through a physical newspaper, a set of cable channels, or a hard copy magazine. The graphical interface, the data management and selection/control mechanism, provides an intuitive manner of selecting the visual segments of interest which are associated with the video signal selections, by length (length of video can be shown on the arc-shaped segment, but, in any event, the length or arc degrees visually and intuitively reflect the length of the video segment), genre (color coding); author, title, rating, etc.

Other functions and features are, of course, contemplated and within the teaching of the present invention, as the same may occur to those of skill in the art. However, without limitation, some functions and features are set forth in the attachment referred to herein as the Appendix. In the context of the present invention, the preferred embodiment of a preliminary yet working prototype is referred to as the Slingshot™ mechanism for controlling and selecting video segments.

I claim:

1. A visual and user interactive interface for controlling the viewing of a set of one or more selectively playable video signal selections on an electronic device having a display screen, said video signal selections stored on a memory device associated with said electronic device, said electronic device further comprising a controller device for selecting from said interface, comprising:
each of said video signal selections being associated with a separate visual segment on said display screen,
a visually-connected and overall-integrated graphical representation of all of said visual segments viewable on said display screen,
such that a user can select by use of said controller the viewing of one or more of said video signal selections from said memory device in the order of user personal preference.

2. A visual and user interactive interface as claimed in claim 1 wherein said graphical representation comprises a substantially unified geometric figure selected from the group consisting of: a circle; a square, a rectangle, a pyramid, a polygon, a ring, and an undulating strip-like line.

3. A visual and user interactive interface as claimed in claim 1 wherein said controller device is a touch-sensitive screen.

4. A visual and user interactive interface as claimed in claim 1 wherein said visual segments are graphically displayed according to their overall playable length of time to view said video signal selections.

5. A visual and user interactive interface as claimed in claim 1 wherein said visual segments are set forth in said graphical representation in two or more colors.

6. A visual and user interactive interface as claimed in claim 1 wherein said visual segments are visually identifiable by topical interest based upon the color(s) provided to said visual segments corresponding to the topic provided by said video signal selection(s).

7. A visual and user interactive interface as claimed in claim 1 wherein said visual segments are color and/or size differentiated based on one or more of the following factors: topic of interest of the video signal selection; length of time of the video signal selection; and a rating of the subject matter of said video signal selection.

8. A visual and user interactive interface as claimed in claim 1 wherein said visual segments vary in visual surface area based on the length of viewing provided by each of said video signal selections in comparison to one another.

9. A visual and user interactive interface as claimed in claim 1 wherein said graphical representation has a substantially circular outer perimeter and said visual segments comprise arcs of the same, with said arcs subtending said perimeter in accordance with the relative playing length of each of said video signal selections of said set.

10. A visual and user interactive interface as claimed in claim 9 wherein said controller is touch sensitive.

11. A visual and user interactive interface as claimed in claim 10 wherein said visual segments are further provided with any one or more of the following information readable therefrom by the user: title of the video signal selection; author of the video signal selection; time of overall play of the video signal selection; brief description of the content of the video signal selection and a rating of the video signal selection.

12. A visual and user interactive interface as claimed in claim 1 wherein said visual segment changes in appearance as each of said video signal selection is played.

13. A visual and user interactive interface as claimed in claim 12 wherein said change in appearance is the change of relative color of said visual segment from a first color to a different hue or tone of said same first color.

14. A data management, selection and control system for an electronic display device comprising:
a memory device capable of storing one or more video signal selections;
one or more video signal selections comprising a set stored on said memory device;
a video display screen for displaying said video signal selection(s) based on said user's selected and thus preferential order of viewing;
a user interface device for allowing a user to select one or more of said video signal selections to be viewed by a user according to said order of preferential viewing;
wherein said user interface device has a separate visual segment for each of said video signal selections, said visual segments being displayed on said video display screen as a substantially integrated, geometric figure on said display screen.

15. A data management, selection and control system for an electronic display device as claimed in claim 12 wherein said geometric figure is selected from the group consisting of: a circle, a ring, a rectangle, a pyramid, a polygon, a continuous strip, an undulating strip and hollows thereof.

16. A data management, selection and control system for an electronic display device as claimed in claim 14 wherein said visual segments are displayed in relative dimension based on the length of time of viewing the entirety of said video signal selection associated therewith.

17. A data management, selection and control system for an electronic display device as claimed in claim 16 wherein said geometric figure has a circular outer perimeter and said relative dimensions are based on the number of degrees subtended by said visual segment around said perimeter.

18. A data management, selection and control system for an electronic display device as claimed in claim 14 wherein said user interface device is a touch sensitive screen and selecting of any one of said visual segment(s) causes said video signal selection corresponding to said visual segment to play on said display screen.

19. A data management, selection and control system for an electronic display device as claimed in claim 14 wherein said separate visual segment(s) are color coordinated corresponding to one or more topical interests of said video signal selection to which they are associated.

20. A data management, selection and control system for an electronic display device as claimed in claim 14 wherein the visual segment associated with the video signal selection then being played on said display screen changes based on the amount of said video signal selection which has been viewed and/or the amount of said video signal selection yet to be viewed.

21. A data management, selection and control system for an electronic display device as claimed in claim 19 wherein one or more of said visual segments are provided with any one or more identifying indicia selected from the group consisting of: Title of the video signal selection, Author of the video signal selection, subject matter of the video signal selection, length of time of the video signal selection, quality rating of the video signal selection, appropriateness of viewing to a particular audience of the video signal election, and summary or description of the video signal selection.

22. A data management, selection and control for an electronic display device as claimed in claim 14 wherein when one of said visual segments is selected for viewing the associated video signal selection, said unified geometric figure is visually decreased in visual prominence on said display screen and said display screen then displays a standard set of visual video controller buttons (at least pause, play, forward, reverse) for said displayed video signal selection.

23. A data management, selection and control for an electronic display device as claimed in claim 14 wherein said unified geometric figure is further provided with a fixed visual selection indicator on said display screen and said unified geometric figure is relatively movable on said display screen with respect to said visual selection indicator to align a selected one of said visual segments with said visual selection indicator for selection for viewing of said selected of said video signal selection on said display screen corresponding to said visual segment so aligned.

24. A data management, selection and control for an electronic display device as claimed in claim 14 wherein the playing of a selected video signal selection from said set allows for a still shot to be displayed on said display screen of at least one of the other video signal selections of said set.

25. A data management, selection and control for an electronic display device as claimed in claim 24 wherein the video signal selection corresponding to any of said displayed still shots can be immediately selected for current display on said display screen by said user interface device to display that video signal selection associated with that still shot as an alternative to the originally selected video signal selection originally displayed.

26. A data management, selection and control for an electronic display device as claimed in claim 14 further comprising a visual, selectable area associated with said visual segments for allowing the user to select access to sharing said video signal selection via social media networking sites.

27. A data management, selection and control for an electronic display device as claimed in claim 14 further comprising at least one of said visual segments being provided with an additional visual segment to provide the user with access to additional video signal selections associated with the visual segment beyond a primary video signal selection associated with said visual segment.

28. A data management, selection and control for an electronic display device as claimed in claim 14 further comprising said visual segments forming a circular graphical element and surrounding or inscribed therein is at least one additional information graphical element associated with at least one of said visual segments for selective display of additional information corresponding to said video signal selection associated with said at least one visual segment.
